(19) United States
(12) Patent Application Publication
(10) Pub. No.: US 2007/0254121 A1
(43) Pub. Date: Nov. 1, 2007

(54) Container With a Label of Stretch Film

(75) Inventors: Jean-Paul Cerveny, Vittel (FR); Cyrille Durand, Coscob, CT (US); Marc Laupie, Nomexy (FR)

Correspondence Address: BELL, BOYD & LLOYD LLP, P.O. Box 1135, CHICAGO, IL, 60690, US

(73) Assignee: Nestle Waters Management & Technology, Issy-les-Moulineaux (FR)

(21) Appl. No.: 11/571,646

(22) PCT Filed: Jul. 13, 2005
(86) PCT No.: PCT/EP05/07624

§ 371 Date: Jan. 4, 2007

(30) Foreign Application Priority Data
Jul. 14, 2004 (EP) 04016524.3

(51) Int. Cl. B65D 25/00; B29C 65/72; B32B 37/12

(52) U.S. Cl. 428/35.7; 156/250; 156/499; 428/34.1

(57) ABSTRACT

The present invention relates to a container (2) comprising a body (23), a neck (22) and a closure element (21), the said body having a surface of positive curvature and including, on its external surface, a stretch film (1) partially covering its surface, made of a plastic different from or the same as that of the body of the said container.

The present invention relates to a container with a label in the form of a stretch film. The invention also relates to a process for obtaining the said container, and also a device for implementing this process.

Bottle labelling systems already exist for placing labels both on glass containers and plastic containers. The most common system is labelling with paper labels. The drawback of this solution is that it is possible to label only containers of substantially cylindrical shape. There is also the possibility of labelling with shrinkable or stretchable plastic sleeves over the entire perimeter of the bottle. In this case, there is no limitation on the shape, that is to say it is possible to place these sleeves on containers other than those that are substantially cylindrical. In this second case, however, the drawback is that if the package is deformed, the sleeve will become detached from the container and a package in two parts will be obtained. Moreover, in the case of these shrinkable sleeves, a high quantity of material is used.

The object of the present invention is to provide a container not having a substantially cylindrical shape on which a label of smaller area is placed, this label forming an integral part of the body of the container if the said container is deformed.

The present invention relates to a container comprising a body, a neck and a closure element, the said body having a surface of positive curvature and including, on its external surface, a stretch film partially covering its surface, made of a plastic different from or the same as that of the body of the said container.

The container may be made of any material, for example plastic, glass or of any other material known in the packaging field. The container is preferably made of a plastic.

The expression “surface of positive curvature” is understood within the present description to mean a container having substantially an ovoid or spherical shape or one that has been etched in relief.

It is important according to the invention for the film covering the external surface of the container to cover the said surface only partially. The term “partially” is understood within the present description to mean that less than 50% of the external surface of the container is covered. The shape of the film applied to the outside of the container is not critical. This film is preferably of substantially circular or elliptical shape. However, the film could also be of square or rectangular shape in the case of a container etched in relief.

As mentioned above, the material of the film applied to the container may be the same as or different from that of the material of the said container. In the first embodiment, the same material is used. In this case, the plastic is chosen from the group consisting of PET, PE, PVC, PP, PS and multilayers with or without an oxygen barrier.

In a second embodiment, the materials are different. In this case, the material of the container is chosen from the abovementioned materials, while the material of the film may also be chosen from the abovementioned materials with, in addition, the possibility of using LDPE.

According to the present invention, the preferred combination is a PET container and an LDPE film.

According to the invention, the film is stretched and adhesively bonded to the container. For the bonding, there are two possibilities, either the film is precoated with adhesive during its manufacture or the adhesive is deposited when the said film is being placed, before or after the said film is heated.

According to another embodiment, the stretch film is printed. In this case, printed matter in colours, printed matter in black and white, or holograms may equally well be provided. Preferably, colour printed matter is used. The printed matter may be either on that face lying against the external surface of the container, or on the external side. Preferably, the printed matter is on that face lying against the external surface of the container. The reason for this is that the ink is protected.

The contents of the container according to the invention are not critical. It is equally possible to have a container that contains a fluid, a semi-fluid or a pasty product. The product in the container may either be a food product or a non-food product, for example a cosmetic or pharmaceutical product. The product may be stable at room temperature, or else it may be refrigerated or even frozen.

The container includes a closure element, which is not critical. It is possible to envisage either a screw cap system or a membrane sealed onto the neck, or any other closure element. In one embodiment, it is also possible not to have a closure element—in this case, the container is sealed. This is possible in the case of a container for enteral or parenteral feeding.

The body of the container has a wall with a thickness of between 5 and 1500 microns. The film bonded to the outside of the container has a thickness of between 5 and 150 microns. Preferably, the film has a thickness of between 5 and 60 microns.

When it is empty, the container according to the invention can be recycled, this being an advantage from the environmental standpoint. Moreover, the container according to the invention is based on a technology allowing savings in material to be achieved, as it is possible, for a given volume of container, to reduce the amount of plastic used by around 20 to 40%.

The present invention also relates to a process for manufacturing the container described above, in which:
filled containers are fed onto a carousel;
the film from a roll is fed onto a heating wheel, the carousel and the heating wheel coming together on a contact region along their circumference;
adhesive is placed on the film or on the container and the said film is heated over the entire perimeter of the heating wheel;
the heated film is applied to the external surface of the container, so as to stretch the film and bond it;
at the same time, the film is cut; and
the container is removed.

As already mentioned above, the adhesive may be applied to the film or to the external surface of the container. However, it is also possible to have a film already precoated with adhesive, in which case it is no longer necessary to apply adhesive. The type of adhesive used is not critical and may be of any type of adhesive used in the art. In particular, a liquid adhesive may be used. This liquid adhesive is preferably in aerosol form, for reasons of industrial practicality.

In the process according to the invention, the film is heated to a temperature corresponding to its softening point. The carousel and the heating wheel rotate at speeds compatible with industrial lines.

Finally, the present invention relates to a device for implementing the process according to the invention, comprising:
a carousel for the filled containers;
a film-heating wheel, the carousel and the heating wheel having a region of contact along their circumference,
   the film-heating wheel comprising, over its entire periphery, several stations, each station having a film support system and a heated cutting system placed in the support.

The carousel has cells in which the various containers are housed. The number of cells is not critical.

The station for heating and cutting the film will be described in greater detail with reference to the drawings appended hereto. The number of stations on the heating wheel is not critical, but it is preferably between 5 and 40. As already mentioned above in the case of the container, the bonded film is substantially circular or elliptical. Consequently, the cutting system is also substantially circular or elliptical.

The rest of the description refers to the drawings in which:

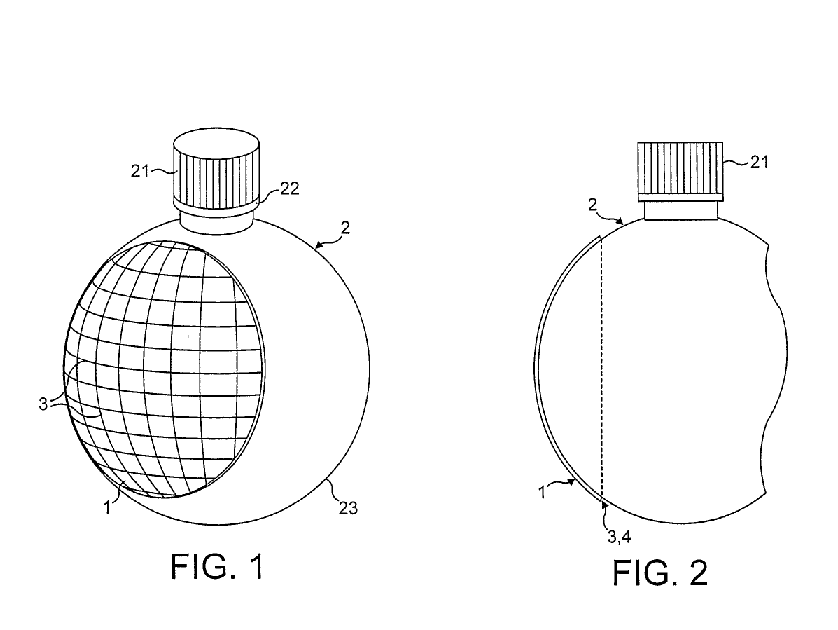

FIG. 1 is a schematic perspective view of the container according to the invention;

FIG. 2 is a side view of the same container;

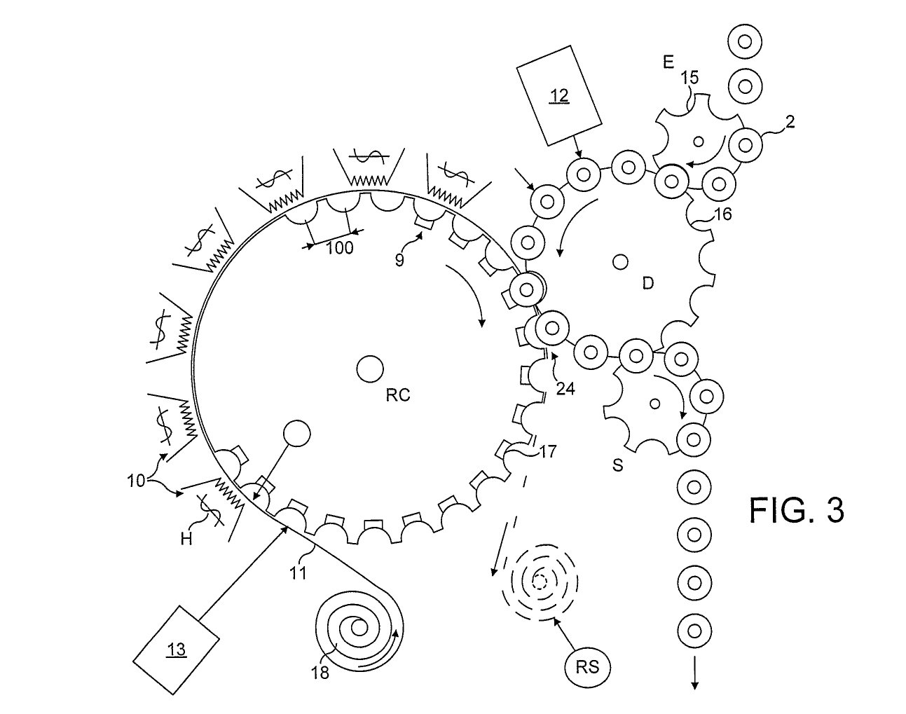

FIG. 3 is a schematic representation of the device according to the invention; and

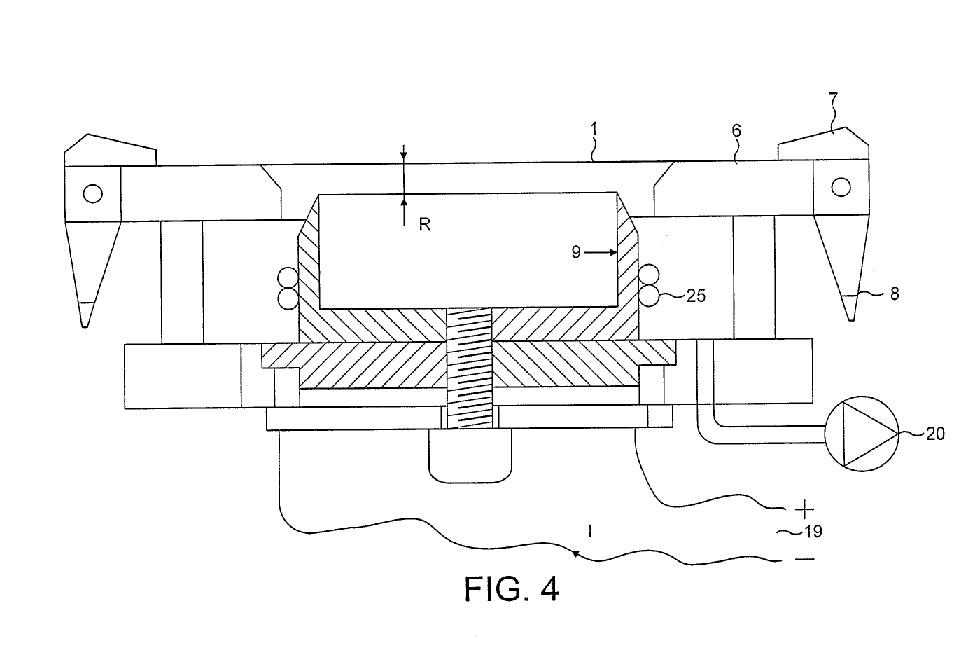

FIG. 4 is a schematic representation of a station on the heating wheel.

A container (2) comprises a neck (22), a body (23) and a closure element (21), which in this case is a screw cap. The present invention relates to the container (2) with a film (1) bonded by the adhesive (4) to the said container. The film includes printed matter (3) and it has been stretched over the surface in three dimensions. This surface is substantially spherical and it may be clearly seen that the film only partially covers the container. As already mentioned above, the printed matter is against the external surface of the said container. The container in the present case contains water and has a wall with a thickness of 80 microns, the film having a thickness of 50 microns. The deposited film has a substantially elliptical shape.

FIG. 3 shows a schematic representation of the device according to the invention. It comprises a carousel E for inputting containers (2), a carousel D for holding the containers (2), a heating wheel RC, a reel (18) for feeding the film (11), a carousel S for outputting the containers (2) and a skeleton roll reel RS. Placed in each cell (17) of the heating wheel is a heated station for cutting the film, as shown in FIG. 4. The contact region between the heating wheel and the carousel D for holding the containers (2) is denoted by (24)—this is the point where the film is placed, bonded and cut. The latter operation is carried out in a time of the order of a tenth of a second, which clearly shows the possibility of operating at industrial line rates.

Before seeing how the device operates, it is important to describe the film-cutting station of FIG. 4. This station comprises a support (6) on which the film (1) rests. The film is held in place by means of a gripper (7) that can be opened by rotating it about the axis (8). Placed inside the support (6) is a heated cutting element (9) for immediately and cleanly cutting the film—the cutting element (9) is placed in the support (6) and preferably heated by a heating resistor (25) connected to the mains at (19). The connection (20) makes it possible to create the vacuum on the outside of the cutter (9) in order to improve the cutting of the film.

The method of operating the device according to the invention may now be described.

Referring in this case to FIG. 3, the containers (2) enter at the same time and at the same speed as the arrival of the film (11). The containers (2) enter the cells (15) via the container input carousel E. These containers then pass onto the carousel D for holding the containers in the cells (16). The containers then enter the region (24). On the other side, from the reel (18), the film (11) is fed onto the heating wheel RC. The film is heated by the heating elements (10) placed over part of the wheel RC. Each cell (17) of the wheel has a station as shown in FIG. 4. When the heated film enters the region (24), since the container will press on the said film, the latter will reduce its distance R from the cutting system (9) until it bears against the said cutting system, and thus the cutting operation and at the same time the bonding against the external surface of the said container are carried out.

As already mentioned above, adhesive (12) may be deposited on the container itself or else, according to another alternative, on the film at (13).

When the film has been bonded to the container, the latter is taken away onto an output carousel S. Likewise, the emptied film (11) is taken off onto the reel RS.

According to the invention, a container comprising a plastic body with a plastic film bonded to the said container is thus manufactured. In the present case, the container is made of PET and the film made of LDPE. It is thus possible to use a printed film of high quality, which enhances the value of the product in the container, and also the whole assembly. What is obtained is a container which, when it is being used, allows its film to closely follow the deformation of the container in order to satisfactorily remove all its contents.

Abbreviations

PET=Polyethylene terephthalate

PE=Polyethylene

PVC=Polyvinylidene chloride

LDPE=Low-density polyethylene

PP=Polypropylene

PS=Polystyrene

1. Container comprising a body, a neck and a closure, the body having a surface having a positive curvature and including, on its external surface, a stretch film partially covering its surface, made of a plastic.

2. Container according to claim 1, wherein the container is made of a plastic selected from the group consisting of polyethylene terephthalate, polyethylene, polyvinylidene chloride, polystyrene and polypropylene.

3. Container according to claim 1, wherein the stretch film is made of a plastic selected from the group consisting of low density polyethylene, polyethylene terephthalate, polyethylene, polyvinylidene chloride, polystyrene and polypropylene.

4. Container according to claim 1, wherein the stretch film is adhesively bonded to the container.

5. Container according to claim 1, wherein the stretch film is printed.

6. Container according to claim 1, wherein the container contains a fluid.

7. Container according to claim 1, wherein the body comprises a wall having a thickness of between 5 and 1500 microns.

8. Container according to claim 1, wherein the stretch film has a thickness of between 5 and 60 microns.

9. Process for manufacturing a container comprising:
feeding filled containers onto a carousel;
feeding film from a roll onto a heating wheel, the carousel and the heating wheel coming together on a contact region along their circumference;
placing adhesive on at least one of the film or the container and heating the film over an entire perimeter of the heating wheel;
applying the heated film to the external surface of the container, so as to stretch the film and bond it;
cutting the film; and
removing the container.

10. Process according to claim 9, wherein the film is heated to a temperature corresponding to its softening point.

11. Process according to claim 9, wherein the heating wheel rotates at speeds compatible with industrial lines.

12. Device comprising:
a carousel for receiving filled containers;
a film-heating wheel, the carousel and the heating wheel having a region of contact along their circumference,
the film-heating wheel comprising, over its entire periphery, several stations, each station having a film support system and a heated cutting system located in the support.

13. Device according to claim 10, wherein the heating wheel has between 20 and 40 stations.

14. Device according to claim 10, wherein the cutting system is substantially circular.

15. Container of claim 1, wherein the body and stretch film are made of a different plastic.

16. Container of claim 1, wherein the body and the stretch film are made of the same plastic.
